(19) United States
(12) Patent Application Publication
(10) Pub. No.: US 2008/0148980 A1
(43) Pub. Date: Jun. 26, 2008

(54) Method for controlling a rotary press and rotary press

(75) Inventors: Pascal Ollivier, Verneuil en Halatte (FR); Jean-Valere Holvoet, Nointel (FR); Francois Vidaillac, Frocourt (FR)

Correspondence Address: Davidson, Davidson & Kappel, LLC, 485 7th Avenue, 14th Floor, New York, NY, 10018, US

(73) Assignee: GOSS INTERNATIONAL MONTATAIRE SA, Montataire (FR)

(21) Appl. No.: 12/005,004

(22) Filed: Dec. 21, 2007

(30) Foreign Application Priority Data
Dec. 22, 2006 (FR) 06 11320

(51) Int. Cl. B41F 1/54

(52) U.S. Cl. 101/484; 101/228

(57) ABSTRACT

A method is provided for a rotary press of the type including cylinders for printing and feeding a web to be printed, and at least one cylinder for feeding said web located downstream of the printing cylinders in the direction of movement of the web.

According to this method, in normal operation, said printing and feed cylinders and the or each downstream feed cylinder are driven in a synchronized manner and, in the event of the web breaking, a step for the differential braking of said printing and feed cylinders and of the or each downstream feed cylinder is implemented.

This claims the benefit of French Patent Application No. 06 11320, filed on Dec. 22, 2006 and hereby incorporated by reference herein.

The present invention relates to a process for controlling a rotary press for printing a web of material, the press being of the type comprising printing units each having at least one cylinder for printing and feeding the web, the press comprising at least one cylinder for feeding said web located downstream of the printing units in the direction of movement of the web.

### BACKGROUND TO THE INVENTION

During printing operations, a web to be printed moves under tension and at high speed on the printing and feed cylinders and on the or each downstream feed cylinder.

The printing and feed cylinders and the downstream feed cylinders are in contact with the web and are driven in rotation in such a manner that they contribute to the feeding of the web. The printing and feed cylinders also print the web by depositing ink thereon.

In the event of the web breaking downstream of a printing unit, the web loses its tension and tends to adhere to the printing cylinders of the printing unit, owing to the ink covering them. There is thus a risk that the web will become wound around one of the printing cylinders, which may very rapidly damage the printing unit owing to an accumulation of layers of web in the printing unit.

### SUMMARY OF THE INVENTION

An object of the invention provides limiting the risks of damage to the printing units in the event of the web breaking.

To that end, the invention provides a process for controlling a rotary press, wherein, in normal operation, said printing and feed cylinders and the or each downstream feed cylinder are driven in a synchronized manner, and, in the event of the web breaking, a step for the differential braking of said printing and feed cylinders and of the or each downstream feed cylinder is implemented.

According to other embodiments, this process may include one or more of the following features, taken in isolation or in accordance with any technically possible combination:

in the event of the web breaking, a preliminary step of synchronized braking may be implemented, in which said printing and feed cylinders and the or each downstream feed cylinder are braked in a synchronized manner, and then the differential braking step is implemented;

in the synchronized braking step, within each printing unit, each printing and feed cylinder may be moved away from an associated counter-pressure cylinder provided to pinch the web against the printing and feed cylinder, and the differential braking step may be started when each printing and feed cylinder has been moved away from the associated counter-pressure cylinder by a predetermined minimum spacing;

in the differential braking step, at least some of the printing and feed cylinders may be braked more rapidly than the or each downstream feed cylinder;

in the differential braking step, the printing and feed cylinders may be braked in a synchronized manner;

in the differential braking step, the printing and feed cylinders may be braked in a differential manner;

in the differential braking step, the printing and feed cylinders located upstream of a breakage point of the web may be braked more rapidly than the printing and feed cylinders located downstream of the breakage point;

in the differential braking step, the printing and feed cylinders located upstream of the breakage point may be braked in a synchronized manner;

in the differential braking step, the printing and feed cylinder(s) of each printing unit may be braked more rapidly than the printing and feed cylinder(s) of the adjacent printing unit located downstream, while at the same time maintaining each printing and feed cylinder and an associated counter-pressure cylinder in a configuration of pinching the web between them;

each printing unit may include two printing groups each comprising a printing and feed cylinder, the printing and feed cylinder of each printing group forming a counter-pressure cylinder for the printing and feed cylinder of the other printing group in order to pinch the web against the printing and feed cylinder of said other printing group;

each printing and feed cylinder may be a blanket cylinder of a printing group also having a plate cylinder.

The invention also provides a rotary press of the type comprising a plurality of printing units each having at least one printing group comprising a cylinder for printing and feeding a web to be printed, and a counter-pressure cylinder for pinching a web to be printed between the counter-pressure cylinder and the printing and feed cylinder, the press also comprising at least one cylinder for feeding said web located downstream of the printing units in the direction of movement of the web, wherein the press comprises means for driving the printing and feed cylinders and the downstream feed cylinders, and control means adapted and programmed for the implementation of a control process such as defined above.

### BRIEF DESCRIPTION OF THE DRAWINGS

The invention and its advantages will be better understood on reading the following description which is given purely by way of example and with reference to the appended drawings in which:

FIG. 1 is a general diagrammatic view of a rotary press;

FIGS. 2 and 3 are diagrammatic views of a printing unit of the press of FIG. 1, in two distinct configurations; and

FIGS. 4 to 6 are graphs illustrating different processes for controlling the press of FIG. 1, these processes being in accordance with the invention.

### DESCRIPTION OF PREFERRED EMBODIMENTS

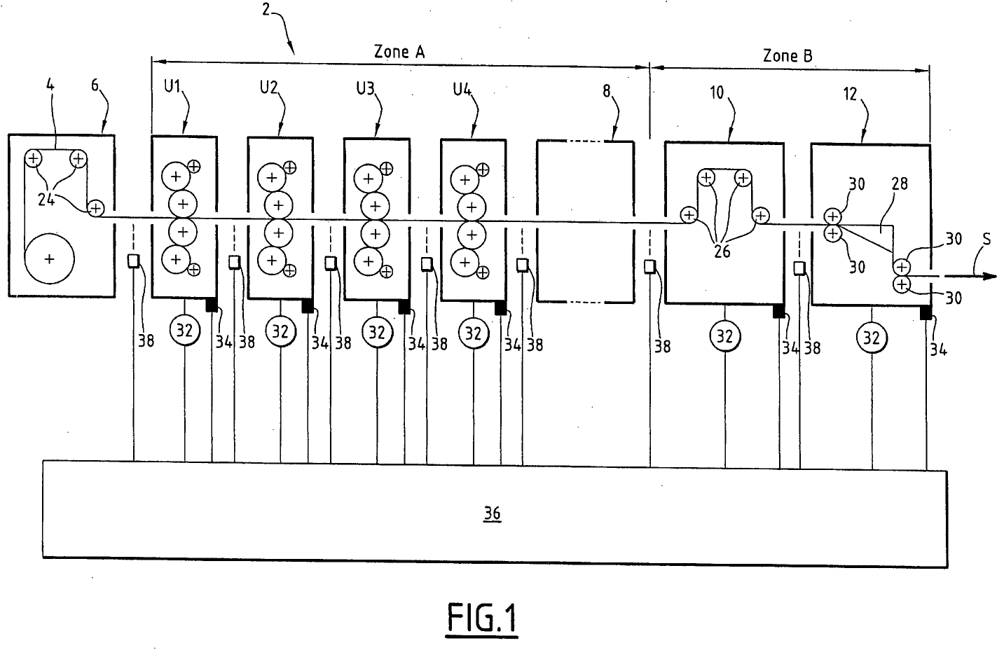

FIG. 1 illustrates a rotary press 2 which is to print a web 4 of material, for example, a web of paper.

During printing operations, the web 4 moves through the press 2, under tension and at high speed, following a path of movement from left to right in FIG. 1, as illustrated by the arrow S.

In the following description, the terms “upstream” and “downstream” are to be understood in relation to the direction of movement of the web 4 in the press 2 following its path of movement.

The press 2 comprises a plurality of functional units, including, in succession from upstream to downstream, an unreeling unit 6, printing units U1, U2, U3 and U4, a drying unit 8, a cooling unit 10 and a folding and/or receiving unit 12.

Units 8, 10 and 12 are optional.

The unreeling unit 6 enables the web 4 to be unwound from a roll. Each printing unit U1, U2, U3, U4 enables the web 4 to be printed recto-verso. The drying unit 8 enables the web 4 to be dried after it has been printed. The cooling unit 10 enables the web 4 to be cooled after it has been dried. The folding unit 12 enables the web 4 to be folded, for example, to form pamphlets.

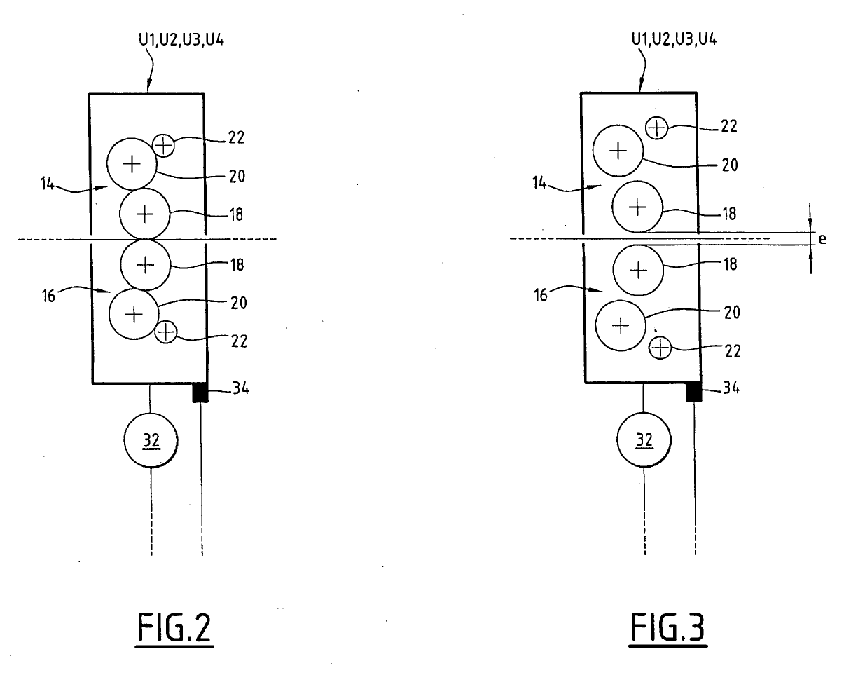

As shown in FIGS. 2 and 3, each printing unit U1, U2, U3 and U4 is a twin unit and comprises two printing groups 14 and 16 located one on each side of the web 4 for recto-verso printing thereof.

Each of the printing groups 14 and 16 comprises a blanket printing cylinder 18, a plate cylinder 20 and an inking cylinder 22, which have parallel axes.

Each printing unit U1, U2, U3, U4 comprises a mechanism for supporting and displacing the cylinders 18, 20, 22 of the printing groups 14 and 16 between a throw-on configuration (FIG. 2) and a throw-off configuration (FIG. 3).

In throw-on configuration (FIG. 2), the cylinders 18 of the printing groups 14 and 16 have been moved close to each other and pinch the web 4 between them. The cylinder 20 of each of the groups 14 and 16 is placed against the cylinder 18 of that group, and the cylinder 22 of each of the groups 14 and 16 is placed against the cylinder 20 of that group.

During printing operations, the groups 14 and 16 are in throw-on configuration. The cylinder 22 deposits ink on one or more plate(s) carried by the cylinder 20 and imposed in accordance with the design to be printed, and the or each plate deposits the ink in accordance with the predetermined design on a blanket carried by the cylinder 18, which deposits the ink on one face of the web 4.

In throw-off configuration (FIG. 3), the cylinders 18 are spaced apart from each other by a spacing e sufficient to allow the web 4 to pass through, that is to say, a spacing e greater than the thickness of the web 4.

The throw-off configuration permits intervention in the printing unit U1, U2, U3, U4 for maintenance operations, for example, in order to change the plates, the blankets or the cylinders.

As shown in FIG. 3, in throw-off configuration, in each of the groups 14 and 16, the cylinder 20 is spaced from the cylinder 18, and the cylinder 22 is spaced from the cylinder 20.

In a variant, in throw-off configuration, the cylinders 18 of the groups 14 and 16 are spaced apart but the cylinders 18, 20 and 22 of the same group 14, 16 are maintained in a state placed against each other.

Returning to FIG. 1, the unreeling unit 6 has cylinders 24 for diverting the web 4, which are free in rotation.

The drying unit 8 comprises means for heating the web 4 in order to dry the ink deposited on the web 4.

The cooling unit 10 comprises cylinders 26 for diverting the web 4.

The folding unit 12 comprises, in the example shown a cone 28 for folding the web 4, for example, in accordance with a longitudinal folding line. The folding unit 12 comprises several pairs of cylinders 30 which are located upstream and downstream of the folding cone 28. The two cylinders 30 of each pair pinch the web 4 between them.

The units U1, U2, U3, U4, 10 and 12 have devices 32 for driving their cylinders 18, 26 and 30, each of those units having its own device 32.

Each device 32 comprises one or more motors. For example, the device 32 of each of the printing units U1, U2, U3 and U4 comprises a motor common to the two printing groups 14 and 16, one motor for each printing group 14 and 16, or one motor for each of the cylinders 18 and 20, and optionally 22.

The press 2 has a detecting device 34 associated with each of the units U1, U2, U3, U4, 10, 12, and a central control system 36 for all of those units.

Each detecting device 34 is suitable for emitting a measurement signal representing the angular position or the angular velocity of the cylinders 18, 26, 30 of the corresponding unit.

The control system 36 is connected to the detecting devices 34 in order to receive the measurement signals emitted therefrom and is connected to the drive devices 32 in order to send them control signals after processing the measurement signals.

During printing operations, the cylinders 18, 26 and 30 are in contact with the web 4 and are each driven in rotation by the device 32 of their unit U1, U2, U3, U4, 10, 12. Those cylinders 18, 26 and 30 feed the web 4 through the press 2.

The rotation of the cylinders 18, 26 and 30 must be synchronized, on the one hand, in order to ensure the movement of the web 4 under tension between the various units of the press 2 and, on the other hand, to ensure correct printing of the web 4, without any shift between the images printed by the various printing units U1, U2, U3, U4.

To that end, the control system 36 controls the cylinders 18, 26 and 30 in respect of angular position and/or angular velocity and ensures that they rotate in a synchronized manner.

It sometimes happens that the web 4 breaks during printing operations owing to the mechanical and thermal stresses to which it is subjected and often as a result of a defect in the web 4.

The press 2 has detectors 38 for web breakage which are located along the path of the web 4. The press 2 comprises, for example, one detector 38 between each pair of adjacent units.

The detectors 38 are detectors of a known type and, for example, optical detectors suitable for detecting a break in the web 4 by the modification of a light beam reflected by the web 4 or passing through the web 4 owing to the loss of tension in the web 4.

In the event of the web 4 breaking downstream of a printing unit, the web 4 tends to adhere to the cylinders 18 of that printing unit owing to the ink covering those cylinders 18. Thus, the web 4 tends to become wound around one of them.

There is a risk that the accumulation of the web 4 wound around a cylinder 18, between that cylinder 18 and the cylinder 20 of the same printing group or between that cylinder 18 and the cylinder 18 of the other printing group of the printing unit, will damage those cylinders, the plates or the blankets carried by those cylinders, or the printing unit as a whole, or will prevent the operation of the press 2 for a variable period owing to the pollution of the press 2 by pieces of the web 4.

The replacement of a cylinder, its plate or its blanket and the restarting of the printing unit are laborious and expensive.

In order to protect the printing units U1, U2, U3 and U4 in the event of the web 4 breaking, an emergency shutdown of the press 2 is implemented in the course of which the feed cylinders of the press 2 are braked, for example, by applying to them a resistant braking moment by means of the motors of the drive devices 32.

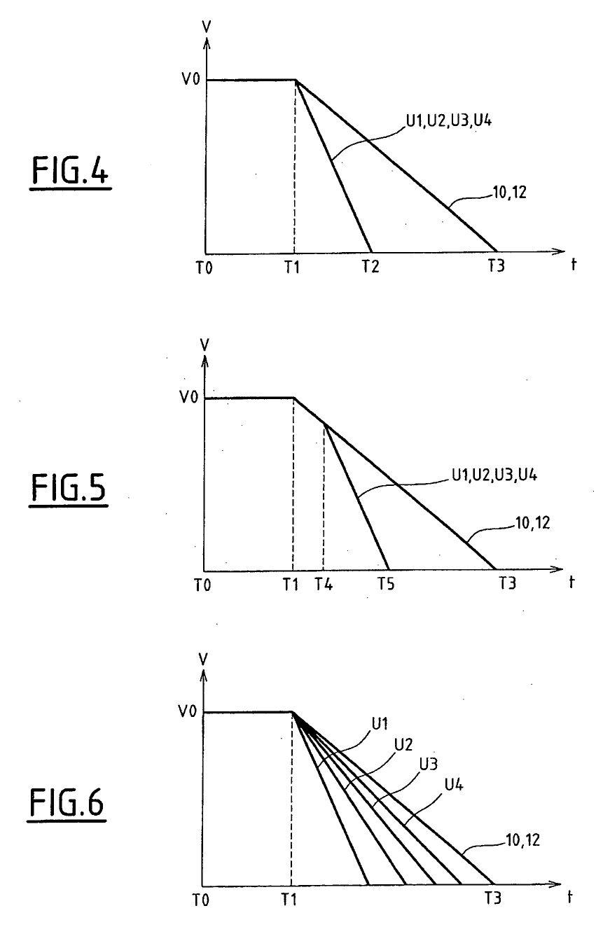

FIG. 4 is a graph showing the rate of movement (y-axis) of the feed cylinders of the press 2, as a function of time (x-axis).

The rate of movement of a feed cylinder is the rate of movement applied by that feed cylinder to the web 4, which is substantially equal to the product of the angular velocity of that cylinder and its radius.

In FIG. 4, in a normal operating phase, between the instants T0 and T1, the feed cylinders are driven in a synchronized manner at the same constant rate of movement V0.

On detecting a breakage of the web 4 at instant T1, a step of emergency shutdown of the press 2 is implemented by braking the feed cylinders of the press 2 by applying a braking moment by means of the motors of the devices 32.

As of the commencement of the emergency shutdown, the printing groups 14, 16 of the printing units U1, U2, U3 and U4 are displaced into throw-off configuration in order to disengage the cylinders 18 from the web 4.

In addition, in accordance with the process of the invention, a step of differential braking of the feed cylinders of the press 2 is implemented.

In particular, in the differential braking step, the cylinders of the printing units U1, U2, U3 and U4, and in particular their cylinders 18, are braked more rapidly than the feed cylinders 26, 30 of the units 10, 12 located downstream of the printing units U1, U2, U3 and U4.

Thus, as shown in FIG. 4, the cylinders 18 of the printing units U1, U2, U3 and U4 are stopped at instant T2, before the feed cylinders 26, 30 of the units 10, 12, which are stopped at an instant T3.

For example, the feed cylinders of the printing units U1, U2, U3 and U4 are stopped in three seconds, while the feed cylinders 26, 30 of the units 10, 12 are stopped in ten seconds.

The faster braking of the cylinders 18 enables a winding thickness of the web 4 around those cylinders 18 to be limited, and consequently limits the risks of damage to those cylinders 18 and to the printing units U1, U2, U3 and U4.

The drive motors of the cylinders 18 are generally of a larger capacity than the motors of the other feed cylinders of the press 2 owing to the larger resistant moments encountered by the cylinders 18. The faster braking of the cylinders 18 is therefore possible without making any structural modification to the press 2 and merely by modifying the programming of the emergency shutdown of the control system 36.

In the embodiment of FIG. 4, the cylinders 18 of the printing units U1, U2, U3 and U4 are slowed down in a manner synchronized with each other and stop at the same instant T2. The feed cylinders of the units 10 and 12 are also stopped in a manner synchronized with each other and stop at the same instant T3.

In a variant illustrated in FIG. 5, on detecting a breakage of the web at instant T1, a preliminary step of synchronized braking is implemented in which the cylinders 18 of the printing units U1, U2, U3 and U4 and the cylinders 26, 30 of the units 10, 12 are slowed down in a synchronized manner, while at the same time displacing the printing groups 14 and 16 of the printing units U1, U2, U3 and U4 into throw-off configuration.

Once the throw-off configuration has been reached, at an instant T4, the differential braking step is implemented as before, by braking the cylinders 18 more rapidly than the cylinders 26 and 30.

The cylinders 18 stop at an instant T5 before the cylinders 26, 30 which stop at instant T3.

The preliminary step of synchronized braking prevents fresh breaks in the web 4 caused by the different decelerations of the web 4 which increase the tension in the web 4.

Advantageously, in order to accelerate the stopping of the printing units U1, U2, U3, U4, the differential braking step is commenced as soon as the spacing between the cylinders 18 of each printing unit U1, U2, U3, U4 is greater than the thickness of the web 4, without waiting to reach the throw-off configuration.

In another embodiment illustrated in FIG. 6, on detecting breakage at instant T1, the printing groups 14 and 16 of the printing units U1, U2, U3 and U4 are kept in throw-on configuration and the cylinders 18 of the printing units U1, U2, U3 and U4 are slowed down in a differential manner.

In a first variant illustrated in FIG. 6, the cylinders 18 of each of the units U1, U2 and U3 are braked more rapidly than those of the adjacent printing unit U2, U3 and U4, respectively, located downstream.

Thus, the deceleration rate of the printing units U1, U2, U3 and U4 decreases from upstream to downstream. The result is that the tension of the web 4 is increased between each pair of adjacent printing units between which the web 4 is still under tension, which is the case if the point of breakage of the web 4 is not located between the two printing units of said pair.

A sufficient increase in tension enables the web 4 to be broken again between the two adjacent printing units, which limits the length of web 4 capable of becoming wound around the cylinders 18 of those printing units.

Thus, for example, if the web 4 breaks initially between the drying unit 8 and the cooling unit 10, the web 4 will be broken owing to the differential braking at three points of secondary breakage, between the units U1 and U2, the units U2 and U3, and the units U3 and U4.

In a second variant, the cylinders of the printing units U1, U2, U3 and U4 located upstream of the point of breakage are braked more rapidly than the cylinders of the printing units U1, U2, U3 and U4 located downstream of the point of breakage.

The risk of becoming wound around downstream of the point of breakage is less great because the downstream portion of the web 4 continues to be fed in the downstream direction by the units of the press 2 located downstream of the point of breakage. Consequently, the differential braking purely of the printing units located upstream of the point of breakage greatly limits the risk of becoming wound around.

In this second variant, the cylinders of the printing units U1, U2, U3 and U4 located upstream of the point of breakage are slowed down in a manner synchronized with each other, or in a manner which is differential with respect to each other, in accordance with the first variant.

The cylinders of the printing units U1, U2, U3 and U4 located downstream of the point of breakage are slowed down at the same rate or more rapidly than the cylinders of the units of the press 2 located downstream of the printing units U1, U2, U3 and U4.

In addition, the risks of becoming wound around are greater when the breakage of the web occurs in a zone A (FIG. 1) of the press 2 between the printing unit U1 the furthest upstream and the cooling unit 12, than when the breakage of the web occurs in a zone B downstream of the zone A.

Consequently, during an emergency shutdown, a differential braking step according to the invention may be implemented when a breakage of the web 4 is detected in the zone A and the differential braking step is not implemented when a breakage of the web is detected in the zone B.

If in the course of the emergency shutdown of the press 2 without differential braking, a fresh breakage of the web 4 is detected in the zone A, a differential braking step according to the invention may be implemented.

A differential braking step may be implemented in accordance with any one of the embodiments and any one of the variants explained above.

What is claimed is:

1 to 12. (canceled)

13. A method for controlling a rotary press for printing a web of material, the press including:
printing units each having at least one printing and feed cylinder for printing and feeding the web in a direction of movement; and
at least one downstream feed cylinder for feeding the web located downstream of the printing units in the direction of movement of the web; the method comprising the steps of:
driving, in normal operation, the printing and feed cylinders and the at least one downstream feed cylinder in a synchronized manner; and,
performing, in the event of the web breaking, differential braking of the printing and feed cylinders and of the at least one downstream feed cylinder.

14. The method as recited in 13 wherein the printing and feed cylinders and the at least one downstream feed cylinder are braked in a synchronized manner during the differential braking step.

15. The method as recited in claim 14 wherein, during the synchronized braking, within each printing unit, each printing and feed cylinder is moved away from an associated counter-pressure cylinder provided to pinch the web against the printing and feed cylinder, and the differential braking step is started when each printing and feed cylinder is moved away from the associated counter-pressure cylinder by a predetermined minimum spacing.

16. The method as recited in claim 13 wherein, during the differential braking step, at least one of the printing and feed cylinders is braked more rapidly than the at least one downstream feed cylinder.

17. The method as recited in claim 13 wherein, during the differential braking step, at least two of the printing and feed cylinders are braked in a synchronized manner.

18. The method as recited in claim 13 wherein, during the differential braking step, one of the printing and feed cylinders is braked in a differential manner with respect to another one of the printing and feed cylinder.

19. The method as recited in claim 18, wherein, during the differential braking step, the printing and feed cylinders located upstream of a breakage point of the web are braked more rapidly than the printing and feed cylinders located downstream of the breakage point.

20. The method as recited in claim 19 wherein, during differential braking, the printing and feed cylinders located upstream of the breakage point are braked in a synchronized manner.

21. The method as recited in claim 13 wherein, during the differential braking step, the printing and feed cylinder of each printing unit is braked more rapidly than the printing and feed cylinder of the adjacent printing unit located downstream, while at the same time maintaining each printing and feed cylinder and an associated counter-pressure cylinder in a configuration of pinching the web between them.

22. The method as recited in claim 13 wherein each printing unit has two printing groups each comprising a printing and feed cylinder, the printing and feed cylinder of each printing group forming a counter-pressure cylinder for the printing and feed cylinder of the other printing group in order to pinch the web against the printing and feed cylinder of said other printing group.

23. The method as recited in claim 13 wherein each printing and feed cylinder is a blanket cylinder of a printing group, the printing group also having a plate cylinder.

24. A rotary press comprising:
a plurality of printing units each having at least one printing group, each printing group comprising a cylinder for printing and feeding a web to be printed, and a counter-pressure cylinder for pinching a web to be printed between the counter-pressure cylinder and the printing and feed cylinder;
at least one downstream feed cylinder for feeding the web located downstream of the printing units in the direction of movement of the web;
a motor for driving the printing and feed cylinders and the downstream feed cylinders; and
a controller driving, in normal operation, the printing and feed cylinders and the at least one downstream feed cylinder in a synchronized manner, and, performing, in the event of the web breaking, differential braking of the printing and feed cylinders and of the at least one downstream feed cylinder.
